(19) United States
(12) Patent Application Publication
(10) Pub. No.: US 2024/0202546 A1
(43) Pub. Date: Jun. 20, 2024

(54) INPUT GENERATION FOR MULTIMODAL LEARNING BASED MACHINE LEARNING MODELS

(71) Applicant: SAP SE, Walldorf (DE)

(72) Inventors: Tassilo Klein, Berlin (DE); Moin Nabi, Berlin (DE)

(21) Appl. No.: 18/067,096

(22) Filed: Dec. 16, 2022

(51) Int. Cl. G06N 5/022

(52) U.S. Cl. CPC G06N 5/022

(57) ABSTRACT

A method and system for generating inputs specific to a multimodal learning based machine learning model. The generating of inputs specific to the multimodal learning based machine learning model from training dataset comprises image data, the generating including: determining a plurality of permutations based on the one or more images included in the image data, and applying orthogonal super-positioning relative to the plurality of permutations. The method further comprises providing the inputs that are generated, based on the orthogonal super-positioning, into the multimodal learning based machine learning model, and generating, by the multimodal learning based machine learning model, a prediction specific to at least one image of the one or more images.

### TECHNICAL FIELD

The subject matter described herein generally relates to multi-modal learning based machine learning models.

### BACKGROUND

Various machine learning training techniques perform image analysis or textual analysis, sentiment analysis, semantic search, similarity determination, and so forth. However, these training techniques are unable to train models such that these models incorporate visual or image analysis with textual analysis in order to perform various tasks.

### SUMMARY

Systems, methods, and articles of manufacture, including computer program products, are provided for training a machine learning model using self-contrastive decorrelation. In one aspect, there is provided a computer-implemented method comprising: generating inputs specific to a multimodal learning based machine learning model from a training dataset comprising image data, the image data comprising a plurality of rules specific to one or more images and a plurality of characterizations representative of orientations of the one or more images, the generating comprising: determining a plurality of permutations based on the one or more images included in the image data, and applying orthogonal super-positioning relative to the plurality of permutations. The method further comprises providing the inputs that are generated, based on the orthogonal super-positioning, into the multimodal learning based machine learning model, and generating, by the multimodal learning based machine learning model, a prediction specific to at least one image of the one or more images.

In some variations, one or more of the features disclosed herein including the following features can optionally be included in any feasible combination. The multimodal learning based machine learning model is a contrastive language-image pre-training model.

In some variations, at least one of the plurality of rules specific to the one or more images corresponds to a color alteration rule. In some variations, at least one of the plurality of rules specific to the one or more images corresponds to a Boolean rule. In some variations, at least one of the plurality of rules specific to the one or more images comprises an orientation specific to each of the one or more images.

In some variations, the applying of the orthogonal super-positioning relative to the plurality of permutations comprises: associating at least a first subset of the plurality of permutations with a first parameter, and associating at least a second subset of the plurality of permutations with a second parameter, wherein the second parameter is oriented orthogonally with respect to the first parameter. The applying of the orthogonal super-positioning relative to the plurality of permutations further comprises associating at least a third subset of the plurality of permutations with a third parameter, and associating at least a fourth subset of the plurality of permutations with a fourth parameter, wherein the fourth parameter is oriented orthogonally with respect to the third parameter.

In some variations, the method further comprises receiving a query regarding at least one image of the one or more images, wherein the at least one image of the one or more images comprises one or more objects.

In some variations, the generating of the prediction specific to the image of the one or more images comprises identifying text that is representative of the one or more objects of the at least one image.

In another aspect, there is provided a system comprising: at least one data processor, and at least one memory storing instructions, which when executed by the at least one data processor, cause operations comprising: generating inputs specific to a multimodal learning based machine learning model from a training dataset comprising image data, the image data comprising a plurality of rules specific to one or more images and a plurality of characterizations representative of orientations of the one or more images, the generating comprising: determining a plurality of permutations based on the one or more images included in the image data, and applying orthogonal super-positioning relative to the plurality of permutations. The operations further comprise providing the inputs that are generated, based on the orthogonal super-positioning, into the multimodal learning based machine learning model, and generating, by the multimodal learning based machine learning model, a prediction specific to at least one image of the one or more images.

In yet another aspect, there is provided a non-transitory computer-readable storage medium comprising programming code, which when executed by at least one data processor, causes operations comprising: generating inputs specific to a multimodal learning based machine learning model from a training dataset comprising image data, the image data comprising a plurality of rules specific to one or more images and a plurality of characterizations representative of orientations of the one or more images, the generating comprising: determining a plurality of permutations based on the one or more images included in the image data, and applying orthogonal super-positioning relative to the plurality of permutations. The operations further comprise providing the inputs that are generated, based on the orthogonal super-positioning, into the multimodal learning based machine learning model, and generating, by the multimodal learning based machine learning model, a prediction specific to at least one image of the one or more images.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to the generation of a user interface for accessing one or more software applications, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example architecture that is used to execute implementations of the present disclosure;

FIG. 2A depicts a schematic representation of generating inputs that comply with the requirements of the trained machine learning model, in accordance with some embodiments;

FIG. 2B depicts a schematic representation of the transformation of the training dataset for the purpose of generating the inputs that satisfy the requirements of the trained machine learning model, in accordance with some embodiments;

FIG. 3 depicts multiple real world applications that involve the use of the trained machine learning model, in accordance with some embodiments;

FIG. 4 depicts a flow diagram for multimodal learning based training of the machine learning model of the present disclosure, in accordance with some embodiments; and

FIG. 5 depicts a computing system that may implement the trained machine learning model, in accordance with some embodiments.

### DETAILED DESCRIPTION

Various machine learning techniques may be currently utilized to train machine learning models to perform image analysis, textual analysis, sentiment analysis, semantic search, similarity determination, etc. However, current techniques may be unable to train machine learning models, such that these models incorporate visual and image analysis with textual analysis in order to accurately perform various tasks.

The multimodal learning based machine learning model described herein addresses and overcomes the above described deficiency. Broadly speaking, the multimodal learning based machine learning model is a contrastive language-image pre-training model. For example, such a model may be, e.g., a Connecting Text and Images (“CLIP”), that is trained specifically on a Relational and Analogical Visual Reasoning based training dataset (“RAVEN” training dataset). The trained model may incorporate visual analysis with textual analysis in order to accurately perform various tasks such as return an image that accurately includes various objects included in a textual inquiry or return a text result based on a particular image. For example, in operation, the trained machine learning model may receive a complicated textual inquiry for an image that includes a rare combination of objects such as “Find the most expensive Italian Vehicle with a Japanese Flag on the Vehicle.” In response, the trained machine learning model may accurately identify a list of the most expensive Italian vehicles, each with one or more Japanese flags fixed on one or more parts of these vehicles (e.g., front windshield, back windshield, side mirrors, and so forth).

In other examples, an image such as a screenshot of a technical problem that a customer may be facing may be captured by a technical support specialist and input into the trained machine learning model, which may identify a textual description of a problem based on the screenshot. Other similar examples are also contemplated. Broadly speaking, the multimodal learning based machine learning model described herein operates to integrate or incorporate, during the training phase and during implementation, data from text or vector representations of text with the data from images or vector representations of images in order to accurately identify images, text, and so forth (e.g., in response to one or more queries). The multimodal learning based machine learning model supplements image data or vector representations of the image data (which represents partial information) with text or vector representations of text. In this way, the multimodal learning based machine learning model operates to identify content (text, images, and so forth) based on a textual query that includes a complicated or rare combination of terms. In this way, the trained machine learning model of the present disclosure may be able to accurately incorporate both text and image data during implementation.

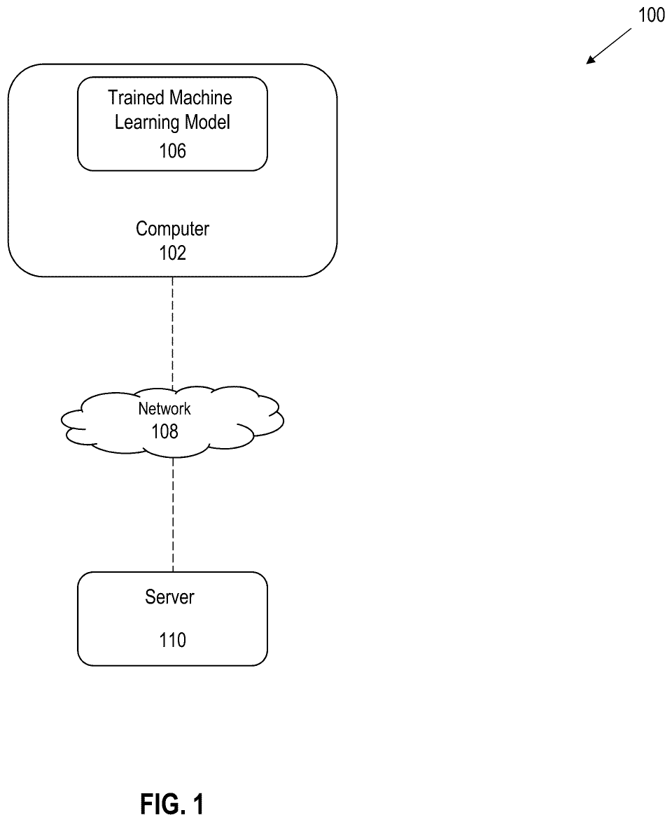

FIG. 1 depicts an example architecture 100 that is used to execute implementations of the present disclosure. In the depicted example, a multimodal learning based machine learning model may be operable on a computer 102, which is communicatively coupled to a server 110, for example, via a network 108. In aspects, the communication between the computer 102 and the server 110 may occur wirelessly and/or via a wired connection. In some aspects, the trained machine learning model 106 may operate as part of one or more software applications for the purpose of performing various tasks such as semantic analysis, textual analysis, text analysis in conjunction with image analysis, image analysis, sentence matching with one or more images, image matching with one or more sentences, and so forth.

In some aspects, the trained machine learning model 106 may be contrastive language-image pre-training based machine learning model that trains, e.g., a CLIP model on a particular training data set, namely a Relational and Analogical Visual Reasoning based training dataset (“RAVEN” training dataset). It is noted that other comparable models are also contemplated. The RAVEN training dataset includes a plurality of images with each image including a limited number of gray-scale objects with clear-cut boundaries. In aspects, the plurality of images of the RAVEN training dataset are absent of occlusions. Further, using at least a subset of these images, various rules (also included in the dataset) may be analyzed or applied in order to perform various tasks. To enable the training of the CLIP machine learning model on the RAVEN training dataset, various transformations may be performed on the RAVEN dataset to generate inputs that correspond with the CLIP machine learning model. For example, the CLIP machine learning model accepts 3-channel (RGB) inputs in the form of images and text, while the RAVEN dataset includes 8 inputs.

Given a sequence of images of the training dataset that includes a particular configuration of gray-scale objects, the multimodal learning based machine learning model may be trained to determine or predict a next image in the sequence of images that corresponds to a particular pattern, based on the configuration of the gray-scale objects in the given sequence of images. The trained machine learning model 106 may operate to determine a text that is representative of, or descriptive of, a given image or a set of images within a threshold accuracy level. The trained machine learning model 106 may operate to identify an image that matches the subject matter included in an inquiry that includes text. The training of the machine learning model enables for the accurate prediction of text that is descriptive of a particular image and the accurate identification of an image that matches the text.

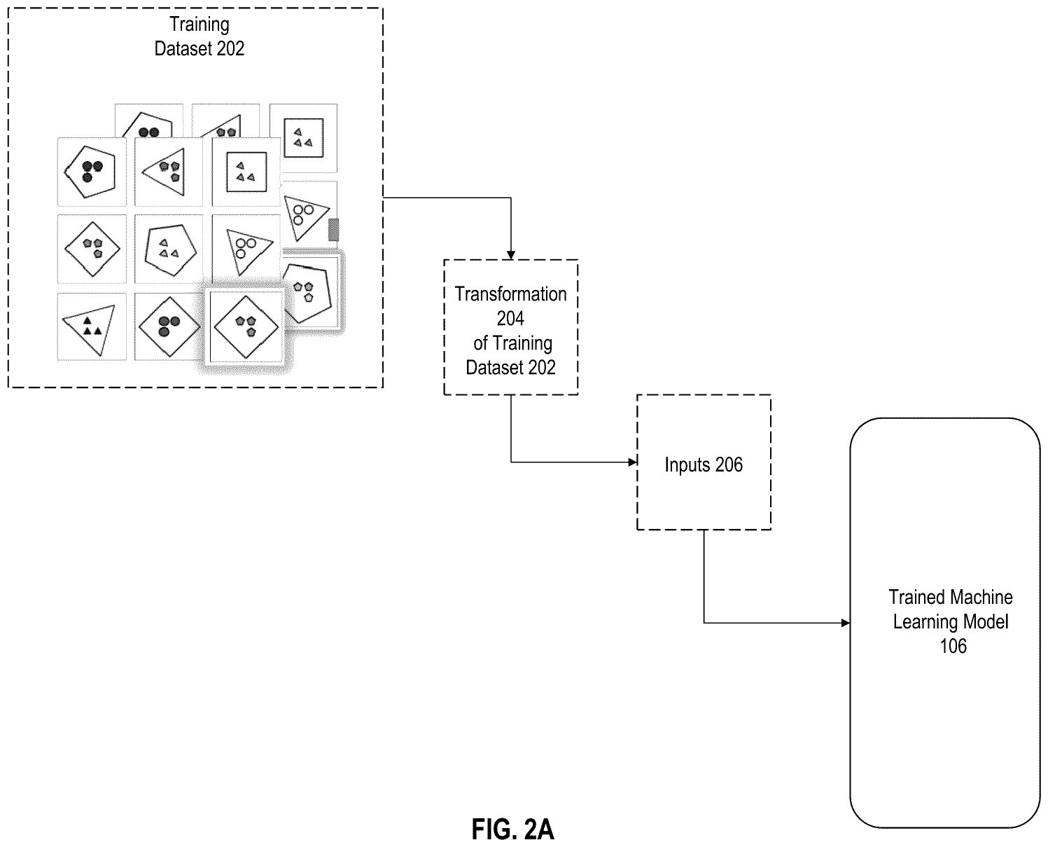

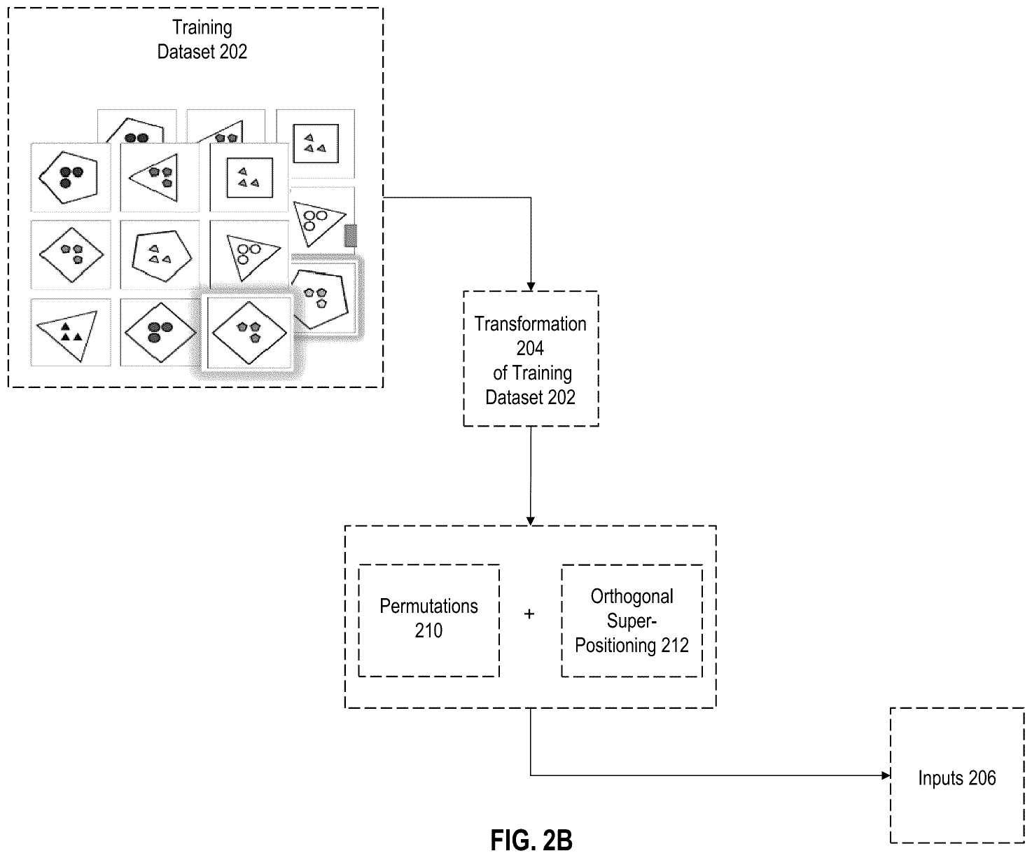

FIG. 2A depicts a schematic representation of generating inputs that comply with the requirements of the CLIP model, in accordance with some embodiments. For example, an example training dataset 202 may be a RAVEN training dataset. The RAVEN training dataset may include 1,120,000 images arranged based on 70,000 RAVEN Progressive Matrices (“RPM”). In this example, each RAVEN progressive matrix includes 16 tree-structure annotations, which total 1,120,000 structural labels for the 1,120,000 images. Moreover, five rule-governing attributes and two noise attributes are utilized in association with the RAVEN training dataset, such that each rule-governing attribute utilizes at least one of the four rules. As such, there are 440,000 rule annotations and an average of 6.29 rules per problem. And the 1,120,000 images of the RAVEN training dataset include a limited set of simple gray-scale objects with clear-cut boundaries. Additionally, these images do not include occlusions. Further, during training of the machine learning model, rules may be applied row-wise, and one rule could be applied to each attribute.

Regarding the RAVEN training dataset, it is noted that a semantic link may be established between visual reasoning and structural reasoning in the RAVEN Progressive Matrices (“RPM”). Each problem in the training dataset may be grounded or associated with a sentence that is derived from an Attributed Stochastic Image Grammar. Further, the RAVEN training dataset set generation process may be split into two stages. The first stage involves sampling a sentence from a pre-defined Attributed Stochastic Image Grammar and the second stage renders an image based on the sentence. Such a structured design makes the dataset diverse and extendable, thereby enabling the generation of tests in various figure configurations.

As part of the generating of the RAVEN training dataset, Attributed Stochastic Image Grammar is utilized as a representation of the RPM and each RPM is a parse tree that instantiates from the Attributed Stochastic Image Grammar. For example, after rules are sampled, grammar may be pruned and a sentence from the pruned sampled rules may be applied to generate a valid row. Such steps may be repeated (e.g., three times) to generate a problem matrix. In this way, a plurality of problem matrices are generated. Thereafter, in order to generate an answer to the problem matrices, attributes may be modified such that the relationships are broken. Further, the structured presentations may be fed into a rendering engine to generate images. The Attributed Stochastic Image Grammar for RPM is associated with five distinct grammar levels—scene, structure, component, and entity. Each grammar level includes multiple instantiations, e.g., different categories or types.

The scene level grammar may choose any available structure that comprises multiple components. Each component branches into layouts that link entities. Attributes are appended to particular level such number and position of the layout, type, size, and color of an entity, and so forth. Each attribute is associated with a value from a finite set. During a sampling process, both the image structure and attribute values may be sampled. Further, two types of noise attributes may be introduced for enabling generation of the RAVEN training dataset, namely the noise attributes of uniformity and orientation. Upon completion of the RAVEN training dataset, 7 configurations may be derived by combining various structures, components, and layouts.

Subsequent to the generation of the RAVEN training dataset, a transformation 204 of the data in the training dataset 202 may be performed in order to generate inputs 206, which may then be input or fed into the trained machine learning model 106. A plurality of permutations or possibilities may be generated, such as possibilities or permutations of images that may correspond to possible answers to the problem matrices of the RAVEN training dataset. Any gaps or partial data may be filled with one or more images that matches a particular pattern and shares a similarity level with one or more images in the RAVEN training dataset. Thereafter, orthogonal super-positioning operations may be performed on the permutations in order to generate the inputs 206, which are in compliance with the input requirements of the trained machine learning model 106, which may be a CLIP model, as described above.

In aspects, the multimodal learning based machine learning model described herein is based on contrastive learning of visual and textual representations. The multimodal learning based machine learning model comprises a text encoder and an image encoder. The text encoder embeds text into a particular space while the image encoder embeds images into a space. The multimodal learning based machine learning model operates to determine a particular text that matches or describes an image. Further, a trained multimodal learning based machine learning model may operate to determine captions or text for an entire range of varied images that include objects that are not included in the training dataset 202.

FIG. 2B depicts details regarding the transformation of the training dataset 202 for the purpose of generating the inputs 206 that satisfy the requirements of the trained machine learning model 106, in accordance with some embodiments. As part of the transformation of the training dataset 202 to generate the inputs 206, permutations 210 or possible solutions to the problem matrices of the training dataset 202 may be determined and orthogonal super-positioning 212 may be applied on each of the determined permutations. Orthogonal super-positioning 212 operates to integrate multiple data elements into a single space or enforce decorrelation by separating or disentangling features. Thereafter, a weighted sum may be applied to the trained multimodal learning based machine learning model in order to generate predictions, e.g., response to image queries, textual queries, and so forth. The use of the multimodal learning based machine learning model enables storing a large number of models in a single parameter.

In some aspects, multiples models may be stored within a single set of parameters. In particular, models may be stored in superposition and be retrieved for various purposes. For example, a large number of models may be stored in a single parameter instance, and these models may undergo thousands of training steps, without significantly interfering with other models within the superposition.

Parameter superposition (“PSP”) may operate to store a plurality of models simultaneously in a single set of parameters by multiplying inputs, which may be represented by the expression (x∈ [symbol] ^{N}), by a weigh matrix, which may be represented by the expression (W∈ [symbol] ^{M×N}). The multiplication may occur in order to compute features, which may be represented by the expression (y=Wₓ). In aspects, parameters for different models, which may be represented by expressions w(1), w(2), and w(3) and may correspond to different tasks, may be stored in superposition with each other in a particular dimensional space. Further, if only a small subspace in [symbol] ^{N} is required by each parameter, each parameter may be transformed using a task-specific linear transformation, represented by the expression Cₖ⁻¹, rows of each WₖCₖ⁻¹ occupy mutually orthogonal subspace in [symbol] ^{N}. Each WₖCₖ⁻¹ occupies a different subspace such that these parameters may be summed together without interference when stored in superposition. The summing of these parameters may be represented by the following expression:

$$W = {\sum }_{i = 1}^{K} {W}_{i} {C}_{i}^{- 1} \qquad ( 1 )$$

Further, the parameters for an individual task may be retrieved using the context Cₖ and may be referred to by [symbol] ₖ. The term of [symbol] ₖ may be represented by the following expression:

$${\dot{W}}_{k} = {WC}_{k} = {\sum }_{i = 1}^{K} {W}_{i} ( {C}_{i}^{- 1} {C}_{k} ) \qquad ( 2 )$$

As the weights are stored in superposition, the retrieved weights ( [symbol] ₖ) are likely to be a noise estimate of Wₖ. In a particular case in which [symbol] = [symbol] , each Cₖ may be an orthogonal matrix representing a rotation. Further, as matrix multiplication is associative, yₖ=(WCₖ)x may be rewritten as yₖ=W(Cₖx) and the PSP model for the purpose of computing outputs for a particular task, e.g., k^{th} task may be represented by the following expression:

$${y}_{k} = W ( {C}_{k} x ) \qquad ( 3 )$$

As such, PSP model learns a single set of parameters W for multiple tasks, after rotating the inputs (x) into orthogonal sub-spaces [symbol] . In some aspects, rotational superposition may be implemented, which involves choosing the context uniformly from orthogonal group O(M). In other aspects, complex superposition and binary superposition may also be implemented. The complex superposition may be represented by the following expression:

$${c}_{k}^{j} = {e}^{i {ϕ}_{j} ( k )} \qquad ( 4 )$$

In the above expression, the term cₖ^{j} is included as part of a complex unit circle. The expression ϕⱼ(k)∈[−π,π] is a phase value for all j may be sampled with uniform probability density, which is represented by the expression

$$p ( ϕ ) = \frac{1}{2 π} .$$

The term cₖ may result in a diagonal orthogonal matrix. Binary superposition refers to the scenario in which phase values are restricted or constrained to two values, represented by the expression [symbol] .

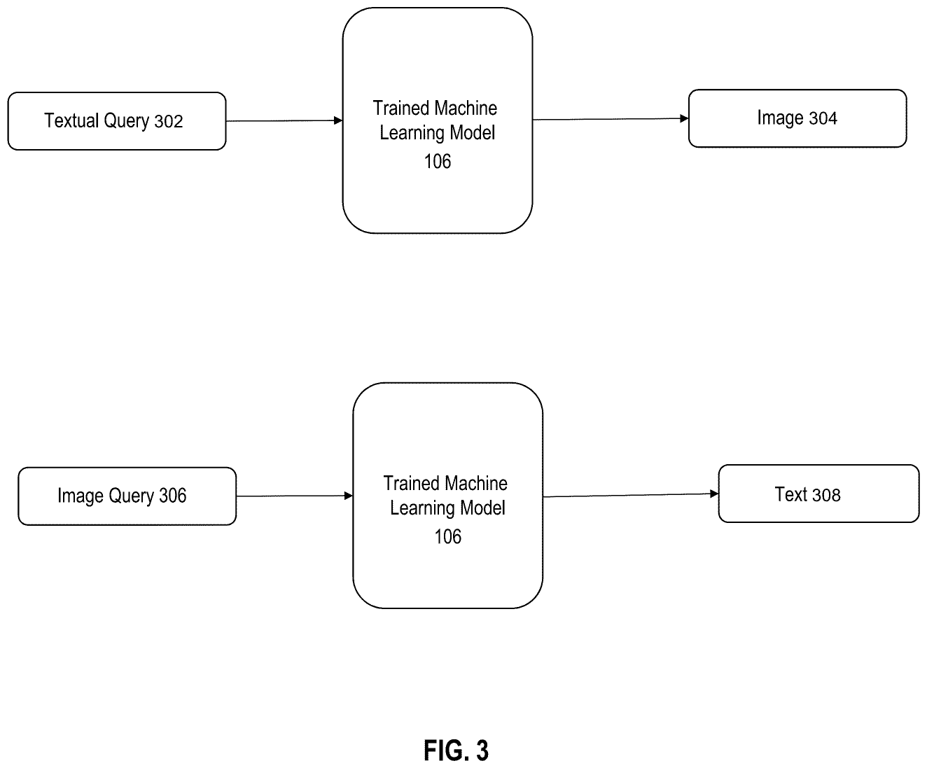

FIG. 3 depicts multiple real world applications that involve the use of the trained machine learning model 106, according to some embodiments.

In the example of FIG. 3, the trained machine learning model 106 may be included as part of a software application, a search engine, and so forth. For example, an information technology professional or a technical support specialist may encounter a computer issue for which there is no clear solution, and as such, the specialist may need to quickly perform a search of a database in order to identify whether a similar problem may have been previously encountered and resolved. In this example, the specialist may capture a screenshot (e.g., an image) of a technical problem occurring on the screen of a client or customer and input the screenshot into the trained machine learning model 106. The trained machine learning model 106 may search through the database and identify another screenshot that is similar to the screenshot that was input, or a textual description of a problem and/or problem and resolution that was similar to the screenshot.

To illustrates further by way of an example, a textual query 302 such as “Identify the most expensive Italian Vehicle having a Japanese Flag” may be input. The trained machine learning model 106 may receive such a query and output an image 304 that may include multiple search results. These results may include various objects that are included in the textual description, namely an expensive Italian Vehicle and a Japanese Flag. The images may include an image of a Ferrari having a Japanese flag fixed on the front windshield, another image of a Maserati having the Japanese flag fixed on the side window and the back windshield, and so forth. In other aspects, an image query 306 may be input into the trained machine learning model 106, e.g., a partial image of, e.g., an invoice, a receipt, or an object that is not clearly visible. In response, the trained machine learning model 106 may determine a text 308 that describes the subject matter of the particular image. It is noted that a plurality of other comparable textual and image based queries may also be input and corresponding results may be determined by the trained machine learning model 106.

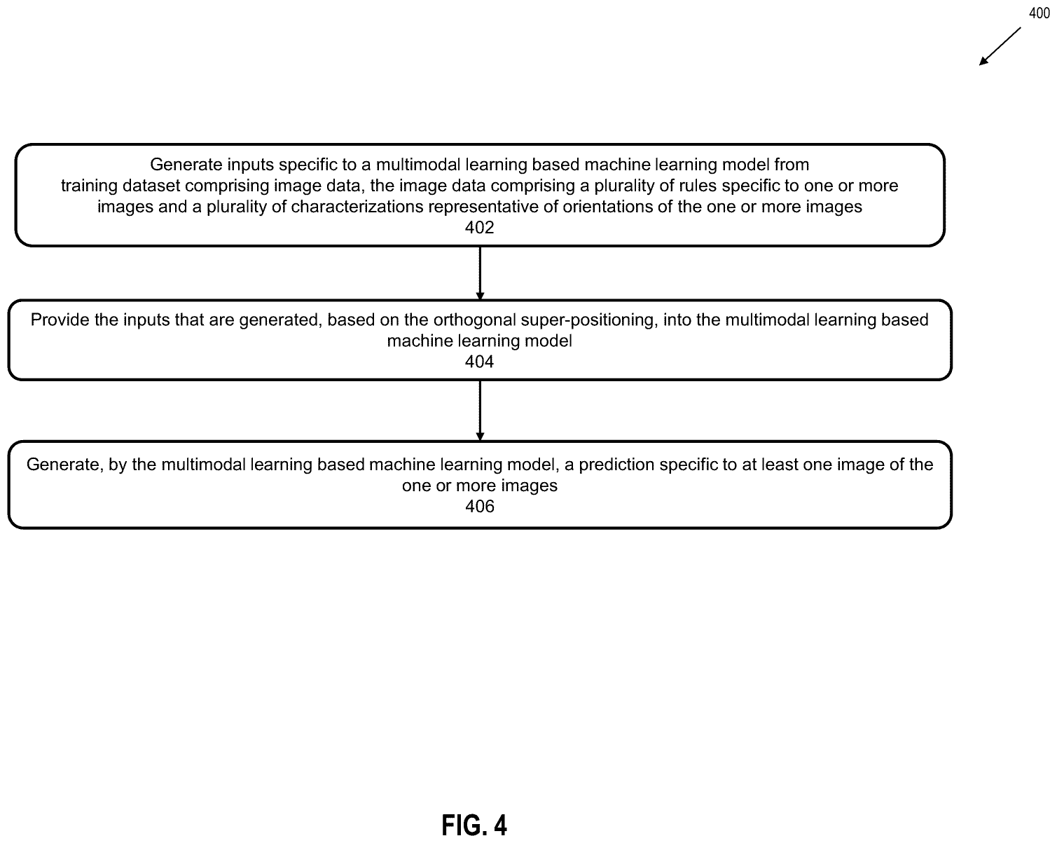

FIG. 4 depicts a flow diagram 400 for multimodal learning based training of the machine learning model of the present disclosure, in accordance with some embodiments.

At block 402, inputs specific to a multimodal learning based machine learning model are generated from a training dataset that comprises image data. The image data includes a plurality of rules specific to one or more images and a plurality of characterizations representative of orientations of the one or more images. As described above, the training data set is a RAVEN training dataset that includes a plurality of images and 440,000 rule annotations and an average of 6.29 rules per problem. It is noted that a plurality of problem matrices and answers are included as part of the RAVEN training dataset. Further characterizations representative of orientations of the one or more images correspond to various configurations. The generating of the inputs include determining a plurality of permutations based on the one or more images included in the image data. As described above, the permutations refer to possible solutions or answers to the problem matrices included in the training dataset 202 (RAVEN training dataset). In addition, the orthogonal super-positioning may be applied relative to the plurality of permutations. The orthogonal super-positioning comprises corresponding at least a first subset of the plurality of permutations with a first parameter and at least a second subset of the plurality of permutations with a second parameter. It is noted that the second parameter may be oriented orthogonally relative to the first parameter in a particular space or dimension. In aspects, at least a subset of the possible solutions or answers to the problem matrices may be associated or stored in relation to a first parameter and at least another subset of the possible solutions or answers to the problem may be stored in relation to a second parameter. Further in a particular space, the second parameter may be stored orthogonally or perpendicularly relative to the first parameter.

At block 404, the inputs that are generated in block 402, based on the orthogonal super-positioning, may be provided to the multimodal learning based machine learning model.

At block 406, a prediction specific to at least one image of the one or more images may be generated. For example, a prediction may refer to an accurate solution to a problem matrix included in the RAVEN training dataset.

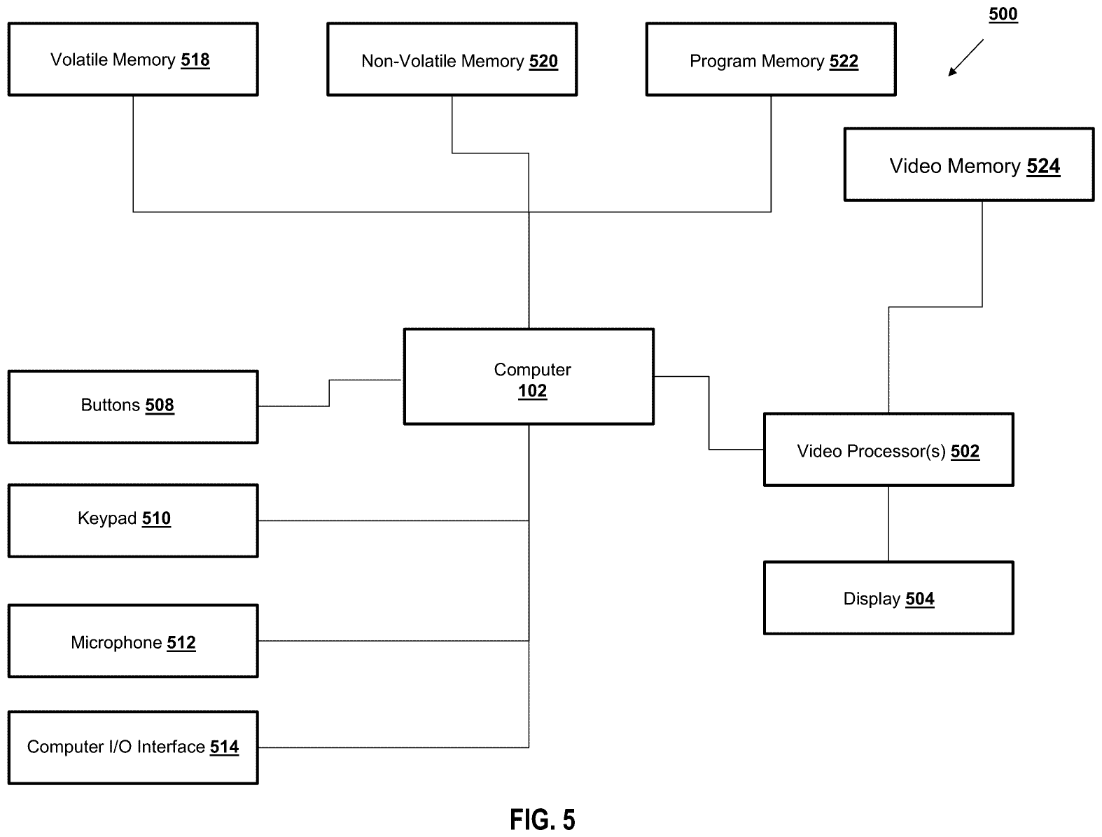

FIG. 5 depicts a computing system 500 that may implement the trained machine learning model 106, according to some embodiments, in accordance with some embodiments. The computing system may include the computer 102 that is communicatively coupled (wired or wirelessly coupled) to a display 504, a keypad 510 (e.g., a keyboard) one or more sensors implanted in the brain of a patient, and one or more brain machine interfaces that are external to the computer 102. The computer 102 may also include video processors 502, buttons 508, a microphone 512, a computer input/output interface 514, memory in the form of volatile memory 518, non-volatile memory 520, and program memory 522.

The video processors 502 can provide/receive commands, status information, streaming video, still video images, and graphical overlays to/from the computer 102 and may be comprised of FPGAs, DSPs, or other processing elements which provide functions such as image capture, image enhancement, graphical overlay merging, distortion correction, frame averaging, scaling, digital zooming, overlaying, merging, flipping, motion detection, and video format conversion and compression.

The computer 102 can be used to manage the user interface by receiving input via buttons 508, keypad 510, and/or microphone 512, in addition to providing a host of other functions, including image, video, and audio storage and recall functions, system control, and measurement processing. The buttons 508 and/or keypad 510 also can be used for menu selection and providing user commands to the server 110 (e.g., freezing or saving a still image). The microphone 512 can be used by the inspector to provide voice instructions to freeze or save a still image.

The video processors 502 can also communicate with video memory 524, which is used by the video processors 502 for frame buffering and temporary holding of data during processing. The computer 102 can also communicate with program memory 522 for storage of programs executed by the computer 102. In addition, the server 110 can be in communication with the volatile memory 518 (e.g., RAM), and the non-volatile memory 520 (e.g., flash memory device, a hard drive, a DVD, or an EPROM memory device). The non-volatile memory 520 is the primary storage for streaming video and still images.

The computer 102 can also be in communication with a computer input/output interface 514, which provides various interfaces to peripheral devices and networks, such as USB, Firewire, Ethernet, audio I/O, and wireless transceivers. This computer input/output interface 514 can be used to save, recall, transmit, and/or receive still images, streaming video, or audio. For example, a USB “thumb drive” or CompactFlash memory card can be plugged into computer input/output interface 514. In addition, the computing system 500 can be configured to send frames of image data or streaming video data to an external computer or server. The computing system 500 can incorporate a TCP/IP communication protocol suite and can be incorporated in a wide area network including a plurality of local and remote computers, each of the computers also incorporating a TCP/IP communication protocol suite.

Further non-limiting aspects or embodiments are set forth in the following numbered examples:

Example 1: A computer-implemented method comprising: generating inputs specific to a multimodal learning based machine learning model from a training dataset comprising image data, the image data comprising a plurality of rules specific to one or more images and a plurality of characterizations representative of orientations of the one or more images, the generating comprising: determining a plurality of permutations based on the one or more images included in the image data, and applying orthogonal super-positioning relative to the plurality of permutations. The method further comprises providing the inputs that are generated, based on the orthogonal super-positioning, into the multimodal learning based machine learning model, and generating, by the multimodal learning based machine learning model, a prediction specific to at least one image of the one or more images.

Example 2: The computer-implemented method of example 1, wherein multimodal learning based machine learning model a contrastive language-image pre-training model.

Example 3: The computer-implemented method of example 1 or 2, wherein at least one of the plurality of rules specific to the one or more images corresponds to a color alteration rule.

Example 4: The computer-implemented method of any one of examples 1-3, wherein at least one of the plurality of rules specific to the one or more images corresponds to a Boolean rule.

Example 5: The computer-implemented method of any of examples 1-4, wherein at least one of the plurality of rules specific to the one or more images comprises an orientation specific to each of the one or more images.

Example 6: The computer-implemented method of any one of examples 1-5, wherein the applying of the orthogonal super-positioning relative to the plurality of permutations comprises: associating at least a first subset of the plurality of permutations with a first parameter, and associating at least a second subset of the plurality of permutations with a second parameter, wherein the second parameter is oriented orthogonally with respect to the first parameter.

Example 7: The computer-implemented method of any one of examples 1-6, wherein the applying of the orthogonal super-positioning relative to the plurality of permutations further comprises associating at least a third subset of the plurality of permutations with a third parameter.

Example 8: The computer-implemented method of any one of examples 1-7, further comprising associating at least a fourth subset of the plurality of permutations with a fourth parameter, wherein the fourth parameter is oriented orthogonally with respect to the third parameter.

Example 9: The computer-implemented method of any one of examples 1-8, further comprising: receiving a query regarding at least one image of the one or more images, wherein the at least one image of the one or more images comprises one or more objects, and wherein the generating of the prediction specific to the image of the one or more images comprises identifying text that is representative of the one or more objects of the at least one image.

Example 10: A system comprises at least one data processor; and at least one memory storing instructions, which when executed by the at least one data processor, cause operations comprising: generating inputs specific to a multimodal learning based machine learning model from a training dataset comprising image data, the image data comprising a plurality of rules specific to one or more images and a plurality of characterizations representative of orientations of the one or more images, the generating comprising: determining a plurality of permutations based on the one or more images included in the image data, and applying orthogonal super-positioning relative to the plurality of permutations. The operations further comprise providing the inputs that are generated, based on the orthogonal super-positioning, into the multimodal learning based machine learning model, and generating, by the multimodal learning based machine learning model, a prediction specific to at least one image of the one or more images.

Example 11: The system of example 10, wherein the multimodal learning based machine learning model is a contrastive language-image pre-training model.

Example 12: The system of example 10 or example 11, wherein at least one of the plurality of rules specific to the one or more images corresponds to a color alteration rule.

Example 13: The system of any of examples 10-12, wherein at least one of the plurality of rules specific to the one or more images corresponds to a Boolean rule.

Example 14: The system of any of examples 10-13, wherein at least one of the plurality of rules specific to the one or more images comprises an orientation specific to each of the one or more images.

Example 15: The system of any of examples 11-14, wherein the one of the operations of applying of the orthogonal super-positioning relative to the plurality of permutations comprises: associating at least a first subset of the plurality of permutations with a first parameter, and associating at least a second subset of the plurality of permutations with a second parameter, wherein the second parameter is oriented orthogonally with respect to the first parameter.

Example 16: The system of any of examples 11-15, wherein the operations further comprise associating at least a third subset of the plurality of permutations with a third parameter.

Example 17: The system of any of examples 11-16, wherein the operations further comprise associating at least a fourth subset of the plurality of permutations with a fourth parameter, wherein the fourth parameter is oriented orthogonally with respect to the third parameter.

Example 18: The system of any of examples 11-17, wherein the operations further comprise: receiving a query regarding at least one image of the one or more images, wherein the at least one image of the one or more images comprises one or more objects, and wherein the generating of the prediction specific to the image of the one or more images comprises identifying text that is representative of the one or more objects of the at least one image.

Example 19: A non-transitory computer-readable storage medium comprising programming code, which when executed by at least one data processor, causes operations comprising: generating inputs specific to a multimodal learning based machine learning model from a training dataset comprising image data, the image data comprising a plurality of rules specific to one or more images and a plurality of characterizations representative of orientations of the one or more images, the generating comprising: determining a plurality of permutations based on the one or more images included in the image data, and applying orthogonal super-positioning relative to the plurality of permutations. The operations further comprise providing the inputs that are generated, based on the orthogonal super-positioning, into the multimodal learning based machine learning model, and generating, by the multimodal learning based machine learning model, a prediction specific to at least one image of the one or more images.

Example 20: The non-transitory computer-readable storage medium of claim 19, wherein the multimodal learning based machine learning model is a contrastive language-image pre-training model.

What is claimed is:

1. A computer-implemented method comprising:
generating inputs specific to a multimodal learning based machine learning model from a training dataset comprising image data, the image data comprising a plurality of rules specific to one or more images and a plurality of characterizations representative of orientations of the one or more images, the generating comprising:
determining a plurality of permutations based on the one or more images included in the image data, and
applying orthogonal super-positioning relative to the plurality of permutations;
providing the inputs that are generated, based on the orthogonal super-positioning, into the multimodal learning based machine learning model; and
generating, by the multimodal learning based machine learning model, a prediction specific to at least one image of the one or more images.

2. The computer-implemented method of claim 1, wherein the multimodal learning based machine learning model is a contrastive language-image pre-training model.

3. The computer-implemented method of claim 1, wherein at least one of the plurality of rules specific to the one or more images corresponds to a color alteration rule.

4. The computer-implemented method of claim 1, wherein at least one of the plurality of rules specific to the one or more images corresponds to a Boolean rule.

5. The computer-implemented method of claim 1, wherein at least one of the plurality of rules specific to the one or more images comprises an orientation specific to each of the one or more images.

6. The computer-implemented method of claim 1, wherein the applying of the orthogonal super-positioning relative to the plurality of permutations comprises:
associating at least a first subset of the plurality of permutations with a first parameter; and
associating at least a second subset of the plurality of permutations with a second parameter, wherein the second parameter is oriented orthogonally with respect to the first parameter.

7. The computer-implemented method of claim 6, wherein the applying of the orthogonal super-positioning relative to the plurality of permutations further comprises associating at least a third subset of the plurality of permutations with a third parameter.

8. The computer-implemented method of claim 7, further comprising associating at least a fourth subset of the plurality of permutations with a fourth parameter, wherein the fourth parameter is oriented orthogonally with respect to the third parameter.

9. The computer-implemented method of claim 1, further comprising:
receiving a query regarding at least one image of the one or more images, wherein the image of the one or more images comprises one or more objects; and
wherein the generating of the prediction specific to the at least one image of the one or more images comprises identifying text that is representative of the one or more objects of the at least one image.

10. A system comprising:
at least one data processor; and
at least one memory storing instructions, which when executed by the at least one data processor, cause operations comprising:
generating inputs specific to a multimodal learning based machine learning model from a training dataset comprising image data, the image data comprising a plurality of rules specific to one or more images and a plurality of characterizations representative of orientations of the one or more images, the generating comprising:
determining a plurality of permutations based on the one or more images included in the image data, and
applying orthogonal super-positioning relative to the plurality of permutations;
providing the inputs that are generated, based on the orthogonal super-positioning, into the multimodal learning based machine learning model; and
generating, by the multimodal learning based machine learning model, a prediction specific to at least one image of the one or more images.

11. The system of claim 10, wherein the multimodal learning based machine learning model is a contrastive language-image pre-training model.

12. The system of claim 10, wherein at least one of the plurality of rules specific to the one or more images corresponds to a color alteration rule.

13. The system of claim 10, wherein at least one of the plurality of rules specific to the one or more images corresponds to a Boolean rule.

14. The system of claim 10, wherein at least one of the plurality of rules specific to the one or more images comprises an orientation specific to each of the one or more images.

15. The system of claim 10, wherein the one of the operations of applying of the orthogonal super-positioning relative to the plurality of permutations comprises:
associating at least a first subset of the plurality of permutations with a first parameter; and
associating at least a second subset of the plurality of permutations with a second parameter, wherein the second parameter is oriented orthogonally with respect to the first parameter.

16. The system of claim 15, wherein the operations further comprise associating at least a third subset of the plurality of permutations with a third parameter.

17. The system of claim 16, wherein the operations further comprise associating at least a fourth subset of the plurality of permutations with a fourth parameter, wherein the fourth parameter is oriented orthogonally with respect to the third parameter.

18. The system of claim 17, wherein the operations further comprise:
receiving a query regarding at least one image of the one or more images, wherein the image of the one or more images comprises one or more objects; and
wherein the generating of the prediction specific to the at least one image of the one or more images comprises identifying text that is representative of the one or more objects of the at least one image.

19. A non-transitory computer-readable storage medium comprising programming code, which when executed by at least one data processor, causes operations comprising:
generating inputs specific to a multimodal learning based machine learning model from a training dataset comprising image data, the image data comprising a plurality of rules specific to one or more images and a plurality of characterizations representative of orientations of the one or more images, the generating comprising:
determining a plurality of permutations based on the one or more images included in the image data, and
applying orthogonal super-positioning relative to the plurality of permutations;
providing the inputs that are generated, based on the orthogonal super-positioning, into the multimodal learning based machine learning model; and
generating, by the multimodal learning based machine learning model, a prediction specific to at least one image of the one or more images.

20. The non-transitory computer-readable storage medium of claim 19, wherein the multimodal learning based machine learning model is a contrastive language-image pre-training model.
